(19) United States
(12) Patent Application Publication
(10) Pub. No.: US 2024/0044113 A1
(43) Pub. Date: Feb. 8, 2024

(54) INFORMATION PROCESSING DEVICE AND NON-TRANSITORY COMPUTER READABLE MEDIUM STORING CONTROL PROGRAM OF INFORMATION PROCESSING DEVICE

(71) Applicant: SUMITOMO HEAVY INDUSTRIES, LTD., Tokyo (JP)

(72) Inventor: Taira MATSUOKA, Yokosuka-shi (JP)

(21) Appl. No.: 18/490,853

(22) Filed: Oct. 20, 2023

Related U.S. Application Data
(63) Continuation of application No. PCT/JP2022/017186, filed on Apr. 6, 2022.

(30) Foreign Application Priority Data
Apr. 23, 2021 (JP) 2021-073151

(51) Int. Cl. E02F 9/26; E02F 9/22

(52) U.S. Cl. CPC E02F 9/267; E02F 9/264; E02F 9/22

(57) ABSTRACT

An information processing device includes an image acquisition unit that acquires an image around a work machine, a recording unit that records the image acquired by the image acquisition unit, a manipulation information acquisition unit that acquires manipulation information relating to a manipulation of the work machine, a state detection unit that detects a state of the work machine and that acquires state information relating to the state, a determination unit that determines whether there is a predetermined difference between the manipulation information acquired from the manipulation information acquisition unit and the state information acquired from the state detection unit, and a recording control unit that causes, in a case where the determination unit determines that there is the difference, the recording unit to record the image including at least an image at a point in time at which the determination is made that there is the difference.

### CROSS-REFERENCE TO RELATED APPLICATIONS

This is a bypass continuation of International PCT Application No. PCT/JP2022/017186, filed on Apr. 6, 2022, which claims priority to Japanese Patent Application No. 2021-073151, filed on Apr. 23, 2021, which are incorporated by reference herein in their entirety.

### BACKGROUND

### Technical Field

The present invention relates to an information processing device and a non-transitory computer readable medium storing a control program of an information processing device.

### Description of Related Art

In the related art, there is known a technique of capturing and recording video data around a vehicle.

As a technique of this type, for example, in a technique described in the related art, in a case where a difference between braking and behavior of a vehicle is detected, video data including a detection point in time thereof is saved as event recording data. An acceleration sensor detects whether or not the behavior of the vehicle corresponds to the braking.

### SUMMARY

An embodiment of the present invention is an information processing device and is configured to include
an image acquisition unit that acquires an image around a work machine,
a recording unit that records the image acquired by the image acquisition unit,
a manipulation information acquisition unit that acquires manipulation information relating to a manipulation of the work machine,
a state detection unit that detects a state of the work machine and that acquires state information relating to the state,
a determination unit that determines whether or not there is a predetermined difference between the manipulation information acquired from the manipulation information acquisition unit and the state information acquired from the state detection unit, and
a recording control unit that causes, in a case where the determination unit determines that there is the difference between the manipulation information and the state information, the recording unit to record the image including at least an image at a point in time at which the determination is made that there is the difference.

Further, an embodiment of the present invention is a non-transitory computer readable medium storing a control program of an information processing device including an image acquisition unit that acquires an image around a work machine, a recording unit that records the image acquired by the image acquisition unit, the program when executed by a processor, causing the processor to:
acquire manipulation information relating to a manipulation of the work machine;
detect a state of the work machine and acquire state information relating to the state;
determine whether or not there is a predetermined difference between the acquired manipulation information and the acquired state information; and
cause, in a case where determination is made that there is the difference between the manipulation information and the state information, the recording unit to record the image including at least an image at a point in time at which the determination is made that there is the difference.

### BRIEF DESCRIPTION OF THE DRAWINGS

FIG. 1 is a side view of an excavator according to the present embodiment.

FIG. 2 is a block diagram showing a system configuration of the excavator of FIG. 1.

FIG. 3 is a diagram showing an imaging range (angle of view) in a horizontal direction of an imaging device according to the present embodiment.

FIG. 4 is a flowchart showing a flow of recording control processing according to the present embodiment.

### DETAILED DESCRIPTION

In a case where the vehicle is a work machine, the work machine itself may vibrate because of work (for example, excavation work). Thus, the acceleration sensor cannot detect the behavior.

The present invention has been made in view of the above circumstances, and it is desirable to suitably perform event recording of a work machine.

Hereinafter, an embodiment of the present invention will be described in detail with reference to the drawings.

### Excavator Configuration

First, a configuration of an excavator 100 according to the present embodiment will be described. The excavator 100 is configured to include an information processing device according to an embodiment of the present invention so that event recording of the excavator 100 is suitably performed.

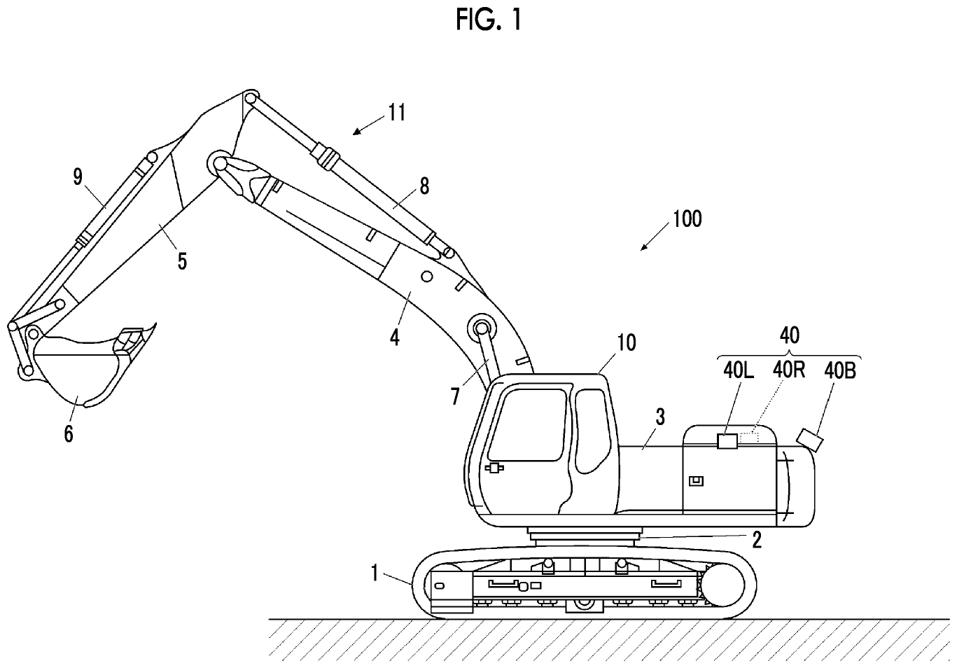

FIG. 1 is a side view of the excavator 100 according to the present embodiment.

As shown in this figure, the excavator 100 includes a lower traveling body 1; a rotating platform 3 that is turnably mounted on the lower traveling body 1 via a turning mechanism 2; a boom 4, an arm 5, and a bucket 6 as an attachment 11; and a cabin 10 on which an operator is boarded. The attachment 11 is not limited thereto as long as a work element (for example, bucket, crusher, or crane device) is provided.

The lower traveling body 1 includes, for example, a pair of left and right crawlers, and each crawler is hydraulically driven by a traveling hydraulic motor (not shown) to cause the excavator 100 to travel.

The rotating platform 3 is driven by a turning hydraulic motor, an electric motor (both not shown), or the like to turn in a horizontal plane with respect to the lower traveling body 1.

The boom 4 is pivotally attached to a center of a front portion of the rotating platform 3 so as to be capable of being elevated, the arm 5 is pivotally attached to a tip of the boom 4 so as to be capable of rotating up and down, and the bucket 6 is pivotally attached to a tip of the arm 5 so as to be capable of rotating up and down. The boom 4, the arm 5, and the bucket 6 are hydraulically driven by a boom cylinder 7, an arm cylinder 8, and a bucket cylinder 9, respectively.

The cabin 10 is a cab on which the operator is boarded, and is mounted on, for example, a left side of the front portion of the rotating platform 3. The excavator 100 causes an actuator to operate in response to a manipulation of the operator boarding the cabin 10 to drive driven elements such as the lower traveling body 1, the rotating platform 3, the boom 4, the arm 5, and the bucket 6.

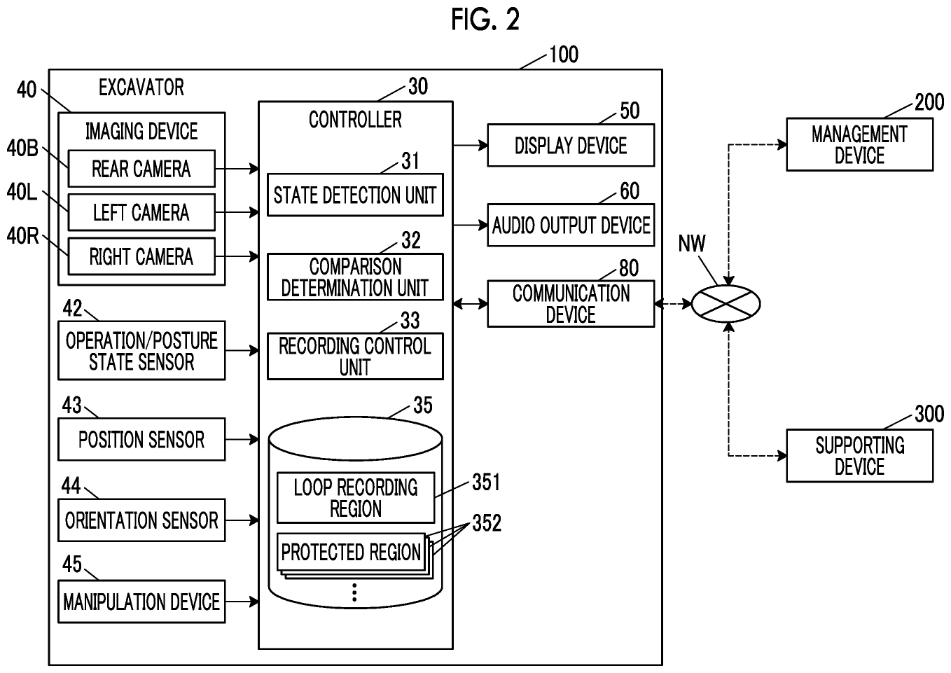

FIG. 2 is a block diagram showing a system configuration of the excavator 100.

As shown in this figure, in addition to the above configuration, the excavator 100 includes a controller 30, an imaging device 40, an operation/posture state sensor 42, a position sensor 43, an orientation sensor 44, a manipulation device 45, a display device 50, an audio output device 60, and a communication device 80. The information processing device according to an embodiment of the present invention includes at least the controller 30.

The imaging device 40 captures an image of a periphery of the excavator 100 and outputs the image to the controller 30. The imaging device 40 includes a rear camera 40B, a left camera 40L, and a right camera 40R. The “periphery” of the excavator 100 need only include at least a predetermined range within a predetermined distance from the excavator 100.

The rear camera 40B is attached to a rear portion of the rotating platform 3 to capture a rear of the rotating platform 3.

The left camera 40L is attached to a left side portion of the rotating platform 3 to capture a left side of the rotating platform 3.

The right camera 40R is attached to a right side portion of the rotating platform 3 to capture a right side of the rotating platform 3.

Each of the rear camera 40B, the left camera 40L, and the right camera 40R is attached to the rotating platform 3 such that each optical axis of the cameras faces diagonally downward, and has an imaging range (angle of view) in a vertical direction including a range from the ground near the excavator 100 to a place distant from the excavator 100.

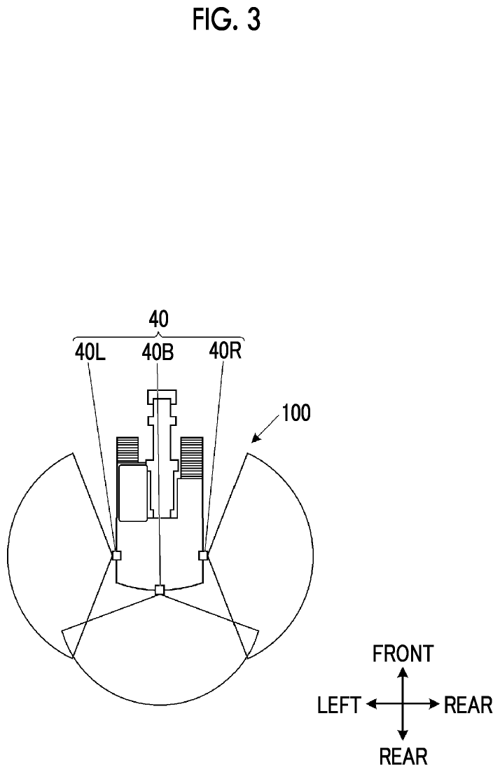

Further, as shown in FIG. 3, the imaging ranges (angles of view) in a horizontal direction of the rear camera 40B, the left camera 40L, and the right camera 40R cover three sides of the excavator 100 excluding a front thereof.

As the imaging device 40, a device that captures the front of the excavator 100 or a device that captures the inside of the cabin 10 may be further provided.

The operation/posture state sensor 42 is a sensor that detects an operation state or a posture state of the excavator 100, and outputs a detection result to the controller 30. The operation/posture state sensor 42 includes a boom angle sensor, an arm angle sensor, a bucket angle sensor, a triaxial inertial measurement unit (IMU), a turning angle sensor, and an acceleration sensor.

These sensors may be configured of a stroke sensor for a cylinder, such as a boom, and a sensor, such as a rotary encoder, that acquires rotation information, or may be replaced by acceleration (speed and position, which may be also included) acquired by the IMU.

The arm angle sensor detects a rotation angle of the arm 5 (hereinafter referred to as “arm angle”) with respect to the boom 4.

The bucket angle sensor detects a rotation angle of the bucket 6 (hereinafter referred to as “bucket angle”) with respect to the arm 5.

The IMU is attached to each of the boom 4 and the arm 5 to detect the acceleration of the boom 4 and the arm 5 along predetermined three axes and angular acceleration of the boom 4 and the arm 5 around the predetermined three axes.

The turning angle sensor detects a turning angle with respect to a predetermined angular direction of the rotating platform 3. However, the present invention is not limited thereto, and the turning angle may be detected based on a GPS or an IMU sensor provided in the rotating platform 3.

The acceleration sensor is attached to a position away from a turning axis of the rotating platform 3 to detect the acceleration of the rotating platform 3 at that position. Accordingly, whether the rotating platform 3 turns, whether the lower traveling body 1 travels, or the like may be discriminated based on a detection result of the acceleration sensor.

The position sensor 43 is a sensor that acquires information on a position (current position) of the excavator 100, and is a Global Positioning System (GPS) receiver in the present embodiment. The position sensor 43 receives a GPS signal including the information on the position of the excavator 100 from a GPS satellite, and outputs the acquired position information of the excavator 100 to the controller 30. The position sensor 43 may not be the GPS receiver as long as the position information of the excavator 100 can be acquired, and may be, for example, a sensor that uses a satellite positioning system other than the GPS. The position sensor 43 may be provided on the lower traveling body 1 or may be provided on the rotating platform 3.

The orientation sensor 44 is a sensor that acquires information on an orientation (direction) in which the excavator 100 faces, and is, for example, a geomagnetic sensor. The orientation sensor 44 acquires the orientation information of the excavator 100 and outputs the orientation information to the controller 30. The orientation sensor 44 only needs to be able to acquire the orientation information of the excavator 100, and a sensor type thereof is not particularly limited. For example, two GPS receivers may be provided, and the orientation information may be acquired from a difference in pieces of position information of the two GPS receivers.

The manipulation device 45 is a manipulation unit that is provided near a cab seat of the cabin 10 and by which the operator manipulates each operation element (lower traveling body 1, rotating platform 3, attachment 11, or the like) of a vehicle body. In other words, the manipulation device 45 is the manipulation unit that manipulates each hydraulic actuator that drives each operation element. The manipulation device 45 includes, for example, a lever or a pedal, and various buttons, and outputs, to the controller 30, a manipulation signal according to manipulation content thereof.

Further, the manipulation device 45 is also the manipulation unit that manipulates the imaging device 40, the operation/posture state sensor 42, the position sensor 43, the display device 50, the audio output device 60, the communication device 80, and the like, and outputs, to the controller 30, a manipulation command to each of these parts.

The display device 50 is provided around the cab seat in the cabin 10, and displays various types of image information to notify the operator under the control of the controller 30. The display device 50 is, for example, a liquid-crystal display or an organic electroluminescence (EL) display, and may be a touch-panel type that also serves as at least a part of the manipulation device 45.

The audio output device 60 is provided around the cab seat in the cabin 10, and outputs various types of audio information to notify the operator under the control of the controller 30. The audio output device 60 is, for example, a speaker or a buzzer.

The communication device 80 is a communication device that transmits and receives, based on a predetermined wireless communication standard, various types of information to and from a remote external device, another excavator 100, or the like through a predetermined communication network NW (for example, a mobile phone network having a base station as a terminal, an Internet network, or the like).

The controller 30 is a control device that controls the operation of each part of the excavator 100 to control the drive of the excavator 100. The controller 30 is mounted inside the cabin 10. A function of the controller 30 may be realized by any hardware, software, or a combination thereof. For example, the controller 30 is mainly configured of a microcomputer including a CPU, a RAM, a ROM, an I/O, and the like. In addition to these, the controller 30 may be configured to include, for example, an FPGA or an ASIC.

Further, the controller 30 includes a state detection unit 31, a comparison determination unit 32, and a recording control unit 33 as functional units that execute various functions. Furthermore, the controller 30 includes a storage unit 35 as a storage region defined in an internal memory such as an electrically erasable programmable read-only memory (EEPROM). The storage unit 35 may be an external memory of the controller 30.

The state detection unit 31 acquires state information relating to a state of the excavator 100 and outputs the state information to the controller 30.

The comparison determination unit 32 compares manipulation information relating to the manipulation of the excavator 100 with the state information of the excavator 100 to determine whether or not there is a predetermined difference between the pieces of information.

The recording control unit 33 controls the storage (recording) of image data acquired by the imaging device 40 into the storage unit 35.

Specific processing content of each of these functional units will be described below.

The storage unit 35 stores various programs for operating each part of the excavator 100, and various pieces of data, such as the image data acquired by the imaging device 40, and also functions as a work region of the controller 30. The storage unit 35 of the present embodiment has a loop recording region 351 and a plurality of protected regions 352 as a recording region for storing the image data acquired by the imaging device 40.

The loop recording region 351 is a recording region where, in a case where the image data is recorded until most of a recording capacity of the loop recording region is occupied, overwrite recording is automatically performed starting from the oldest data and the recording is continued.

The protected region 352 is a recording region where the overwrite recording is prohibited, and is a recording region that protects the recorded image data. At least one protected region 352 need only be used.

Further, the excavator 100 can mutually communicate with a management device 200 through the predetermined communication network NW. For example, the communication network NW may include a mobile communication network having a base station as a terminal. Further, the communication network NW may include a satellite communication network that uses a communication satellite in the sky. Further, the communication network NW may include an Internet network or the like. Further, the communication network NW may include a short-range communication network that conforms to a protocol such as Wi-Fi or Bluetooth (registered trademark). Accordingly, the excavator 100 can transmit (upload) various kinds of information to the management device 200.

Further, the excavator 100 may be configured to mutually communicate with a supporting device 300 through the communication network NW.

The management device 200 (an example of an external device and an information processing device) is disposed at a position geographically away from a user or the like who owns the excavator 100 and the supporting device 300. The management device 200 is, for example, a server device that is installed in a management center or the like provided outside a work site where the excavator 100 works and is mainly configured of one or a plurality of server computers or the like. In this case, the server device may be an in-house server operated by a business operator operating the system or by a related business operator associated with the business operator, or may be a rental server. Further, the server device may be a so-called cloud server. Further, the management device 200 may be a server device (so-called edge server) disposed in a management office or the like in the work site of the excavator 100, or may be a stationary or portable general-purpose computer terminal.

As described above, the management device 200 can mutually communicate with each of the excavator 100 and the supporting device 300 through the communication network NW. Accordingly, the management device 200 can receive and store (accumulate) various types of information uploaded from the excavator 100. Further, the management device 200 can transmit various types of information to the supporting device 300 in response to a request from the supporting device 300.

The supporting device 300 (an example of a user terminal and a terminal device) is a user terminal used by the user. The user may include, for example, a supervisor and a manager of the work site, the operator of the excavator 100, a manager of the excavator 100, a serviceman of the excavator 100, and a developer of the excavator 100. The supporting device 300 is, for example, a general-purpose portable terminal such as a laptop-type computer terminal, a tablet terminal, or a smartphone owned by the user. Further, the supporting device 300 may be a stationary general-purpose terminal such as a desktop computer. Further, the supporting device 300 may be a dedicated terminal (portable terminal or stationary terminal) for receiving information.

The supporting device 300 can mutually communicate with the management device 200 through the communication network NW. Accordingly, the supporting device 300 can receive the information transmitted from the management device 200 and provide the information to the user through a display device mounted on the supporting device 300. Further, the supporting device 300 may be configured to mutually communicate with the excavator 100 through the communication network NW.

### Excavator Operation

Subsequently, an operation of the excavator 100 in a case where recording control processing of controlling the recording of the image data around the excavator 100 during work is executed will be described.

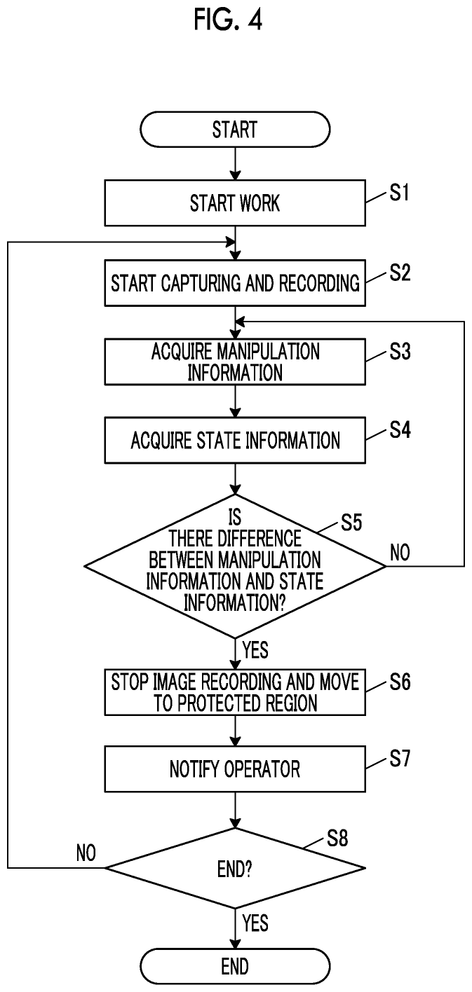

FIG. 4 is a flowchart showing a flow of the recording control processing.

The recording control processing is executed by the controller 30 executing a predetermined program stored in an internal storage device on the CPU. This processing may be executed or terminated based on the manipulation of the operator, or may be continuously executed during the operation of the excavator 100.

In the recording control processing, as shown in FIG. 4, in a case where the work is started by an operation manipulation of the excavator 100 by the operator (step S1), the controller 30 acquires the image (video) data around the excavator 100 via the imaging device 40 and causes the storage unit 35 to record the acquired image data at any time (step S2). Here, the controller 30 causes the image data acquired in a normal state to be recorded in the loop recording region 351 of the storage unit 35.

In the following description, the image (or image data) refers to an image acquired by the imaging device 40 unless otherwise specified.

Next, the controller 30 acquires manipulation information relating to the manipulation of the excavator 100 from the manipulation device 45 (step S3).

Here, the “manipulation information” relating to the manipulation of the excavator 100 is the manipulation command (manipulation content) to the manipulation device 45 by the operator, and refers to information including at least the manipulation command relating to the operation and posture of the vehicle body (including lower traveling body 1 and rotating platform 3) of the excavator 100. The “vehicle body” of the excavator 100, which is a detection target, may include the attachment 11.

Next, in the controller 30, the state detection unit 31 acquires the state information relating to the state of the excavator 100 (step S4).

Here, the “state information” relating to the state of the excavator 100 refers to the information relating to at least the operation state and the posture state of the vehicle body (including the lower traveling body 1 and the rotating platform 3) of the excavator 100. The “vehicle body” of the excavator 100, which is a detection target, may include the attachment 11. In this case, it is preferable that a front camera that captures the front of the excavator 100 is included in the imaging device 40 and that the front camera can capture an image of the attachment 11.

In the present embodiment, the state detection unit 31 acquires the state information of the excavator 100 based on the image data acquired by the imaging device 40. Specifically, an image feature amount is extracted from the image data, and the operation or posture of the excavator 100 is detected. The image feature amount need only be any amount as long as the operation/state of the excavator 100 can be detected by, for example, an optical flow.

The state detection unit 31 may acquire the state information of the excavator 100 from various sensors mounted on the excavator 100 (for example, operation/posture state sensor 42, position sensor 43, orientation sensor 44, and the like), various actuators (for example, electromagnetic valve that performs hydraulic control), and various control devices. For example, the state detection unit 31 can acquire the position and orientation of the excavator 100 via the position sensor 43 and the orientation sensor 44, and can detect an operation or load of the bucket 6 to detect an excavation operation of the attachment 11.

Next, in the controller 30, the comparison determination unit 32 determines whether or not there is the predetermined difference (differential) between the manipulation information acquired in step S3 and the state information acquired in step S4 (step S5).

Here, the fact that there is the “predetermined difference” between the manipulation information and the state information means that the manipulation content (manipulation information) of the operator, which is an input, is substantially inconsistent with the operation/posture state (state information) of the excavator 100, which is an output. Therefore, for example, a detection error of the manipulation information or of the state information is not included in the “predetermined difference”. Further, the predetermined difference (differential) can be adjusted as appropriate. For example, a condition may be set, as the difference, in which a movement direction vector of the excavator 100 is significantly different by a predetermined angle or more.

In step S5, in a case where determination is made that there is no predetermined difference between the manipulation information and the state information (they are substantially consistent) (step S5; No), the controller 30 shifts the processing to step S3 described above.

On the other hand, in step S5, in a case where determination is made that there is the predetermined difference between the manipulation information and the state information (they are substantially inconsistent) (step S5; Yes), the controller 30 causes the recording control unit 33 to stop the recording of the image data into the loop recording region 351 (step S6).

Further, in this case, the recording control unit 33 moves, to the protected region 352, the image data (itself or copy thereof) in a time range that is moved back by a predetermined time from a point in time at which the difference is detected. However, the image data to be moved need only include at least data at a point in time at which determination is made that there is the difference. Accordingly, the image data at the point in time at which the difference between the manipulation information and the state information is detected can be saved avoiding overwrite recording. Furthermore, an image after the detection point in time may also be recorded in the protected region 352.

In this step, the image data need only be recorded in the storage unit 35 at least, and the image data may not be moved to the protected region 352 or the recording of the image data into the loop recording region 351 may not be stopped.

A situation in which the manipulation content of the operator is substantially inconsistent with the operation/posture state of the excavator 100 (for example, a situation in which the vehicle body travels or turns in a direction different from a direction instructed (manipulated)) means that there may be a situation in which an accident has already occurred or, even in a case where the accident has not occurred, there may be a machine failure or the like.

Therefore, with the saving of the video including the point in time at which the inconsistency is detected (preferably further including before and after the point in time) as the event recording (recording of a situation or phenomenon different from a normal state), it is possible for the video to be useful in investigating a cause of the generated phenomenon. Further, there may be a case where there is a bug such as the occurrence of the phenomenon during a specific manipulation. In this case, the recorded video can be useful as a verification material.

Here, specific examples of the situation in which the manipulation content (manipulation information) of the operator is substantially inconsistent with the operation/posture state (state information) of the excavator 100 will be described below.
(1) A case where an advancing direction or turning direction of a work machine included in the manipulation information is different from an operation direction of the work machine included in the state information.
   In an instance where the vehicle body protrudes out on a cliff, an instruction (manipulation) to move forward a little is issued, but the vehicle body sinks. →Actual situation: A foundation has begun to collapse.
   In an instance where the vehicle body travels across an inclined surface, an instruction to move forward is issued, but the vehicle body moves to a left side. →Actual situation: Sliding down.
   In an instance where the vehicle body climbs an inclined surface, the instruction to move forward is issued, but the vehicle body moves backward. →Actual situation: Sliding down.
   In an instance where work is performed near a steep inclined surface, the instruction to move forward is issued, but the vehicle body rotates. →Actual situation: Overturning.
   During normal traveling, the instruction to move forward is issued, but the vehicle body suddenly moves to the left. →Actual situation: Something collides from the right.
   During loading and unloading work of earth and sand, an instruction to turn to the right is issued, but the vehicle body stops. →Actual situation: Collision with something on a right side.
   During the loading and unloading work of earth and sand, the instruction to turn to the right is issued, but the vehicle body moves to a left side. →Actual situation: Something rushes in from the right side, or the machine breaks down.
(2) A case where the manipulation information includes the stop instruction of the excavator 100 and the state information includes the movement of the excavator 100.
   In an instance where the vehicle body stops on an inclined surface or on a filling, the stop instruction is issued, but the vehicle body moves. →Actual situation: Sliding down.
(3) A case where the state information includes rotation in a direction different from the turning direction of the rotating platform 3.
   The vehicle body rotates vertically (rotates within substantially vertical plane). →Actual situation: Overturning.

Next, the controller 30 notifies the operator that there is the predetermined difference between the manipulation information and the state information, that is, that the manipulation content of the operator is substantially inconsistent with the operation/posture state of the excavator 100 (step S7).

This notification mode is not particularly limited as long as the operator can be notified. For example, the display device 50 or the audio output device 60 may be made to output a predetermined notification display or notification audio.

Next, the controller 30 determines whether or not to end the recording control processing (step S8). In a case where determination is made not to end the recording control processing (step S8; No), the processing shifts to step S2 described above, and the work is continued.

In a case where determination is made to end the recording control processing, for example, because of the end of the work (step S8; Yes), the controller 30 ends the recording control processing.

### Technical Effects of Present Embodiment

As described above, according to the present embodiment, the determination is made whether or not there is the predetermined difference between the manipulation information relating to the manipulation of the excavator 100 and the state information relating to the state of the excavator 100. In a case where the determination is made that there is the difference therebetween, the image data including at least the data at the point in time at which the determination is made that there is the difference therebetween is recorded in the storage unit 35.

Accordingly, it is possible to suitably perform the event recording in a case where there is a possibility that the situation or phenomenon different from the normal state has occurred.

Further, according to the present embodiment, in a case where the determination is made that there is the predetermined difference between the manipulation information and the state information, the image data including at least the data at the point in time at which the determination is made that there is the difference therebetween is transferred to the protected region 352 where the overwrite recording is prohibited.

Accordingly, it is possible to prevent the overwrite recording from being performed on the image data at the point in time at which the difference between the manipulation information and the state information is detected. As a result, it is possible to more preferably perform the event recording in a case where there is a possibility that the situation or phenomenon different from the normal state has occurred.

Further, according to the present embodiment, in a case where the determination is made that there is the predetermined difference between the manipulation information and the state information, the recording of the image data into the loop recording region 351 is stopped.

Accordingly, it is possible to prevent the overwrite recording from being performed on the image data in the loop recording region 351.

Further, according to the present embodiment, the state information of the excavator 100 is acquired based on the image data acquired by the imaging device 40.

Accordingly, since the state information can be acquired by using the image data, which is a recording target, it is possible to acquire the state information with a simple configuration without requiring a dedicated device for acquiring the state information.

### Other

The embodiments according to the present invention have been described above. However, the present invention is not limited to the above-described embodiments and modification examples of the embodiments.

For example, in the above embodiment, in a case where the determination is made that there is the predetermined difference between the manipulation information and the state information, the recording of the image data into the storage unit 35 is controlled. However, in addition to this, the storage unit 35 may record log information indicating that the predetermined difference is detected in association with the image data. The log information includes, for example, at least one of a date and time, a place (work site), operator identification information, excavator identification information, a surrounding environment (for example, weather), work content, the manipulation information, or the state information. Further, the log information may be transmitted to the management device 200 or the supporting device 300 for recording.

Further, in the above embodiment, the imaging device 40 is mounted on the excavator 100. However, the imaging device 40 may not be mounted on the excavator 100, and may be, for example, installed in a high place or mounted on an unmanned aircraft such as a drone. The acquired data may be transmitted to the excavator 100, or the data may be transmitted to the management device 200 or the supporting device 300 to execute the detection processing, and a result thereof may be transmitted to the excavator 100. That is, the information processing device according to an embodiment of the present invention may not be mounted on a vehicle such as the excavator, or may be configured as a system including the vehicle and an external processing device.

Further, the work machine according to the present invention may be a work machine other than the excavator, for example, a wheel loader, an asphalt finisher, a forklift, or a crane.

In addition, changes can be made as appropriate to the detailed parts shown in the embodiment within a range not departing from the concept of the invention.

### INDUSTRIAL APPLICABILITY

As described above, the present invention is useful for suitably performing the event recording of the work machine.

It should be understood that the invention is not limited to the above-described embodiment, but may be modified into various forms on the basis of the spirit of the invention. Additionally, the modifications are included in the scope of the invention.

What is claimed is:

1. An information processing device comprising:
an image acquisition unit that acquires an image around a work machine;
a recording unit that records the image acquired by the image acquisition unit;
a manipulation information acquisition unit that acquires manipulation information relating to a manipulation of the work machine;
a state detection unit that detects a state of the work machine and that acquires state information relating to the state;
a determination unit that determines whether or not there is a predetermined difference between the manipulation information acquired from the manipulation information acquisition unit and the state information acquired from the state detection unit; and
a recording control unit that causes, in a case where the determination unit determines that there is the difference between the manipulation information and the state information, the recording unit to record the image including at least an image at a point in time at which the determination is made that there is the difference.

2. The information processing device according to claim 1,
wherein the recording unit includes a protected region in which overwrite recording is prohibited, and
in a case where the determination unit determines that there is the difference between the manipulation information and the state information, the recording control unit moves, to the protected region, the image including at least the image at the point in time at which the determination is made that there is the difference.

3. The information processing device according to claim 1,
wherein the recording unit includes a loop recording region on which the overwrite recording is automatically performed, and
the recording control unit causes, in a normal state, the image acquired by the image acquisition unit to be recorded in the loop recording region.

4. The information processing device according to claim 3,
wherein, in a case where the determination unit determines that there is the difference between the manipulation information and the state information, the recording control unit causes the recording of the image into the loop recording region to be stopped.

5. The information processing device according to claim 1,
wherein the state detection unit acquires the state information based on the image acquired by the image acquisition unit.

6. The information processing device according to claim 1,
wherein the work machine includes an undercarriage and a turning body, and
in a case where an advancing direction or a turning direction of the work machine included in the manipulation information is different from an operation direction of the work machine included in the state information, the determination unit determines that there is the difference between the manipulation information and the state information.

7. The information processing device according to claim 1,
wherein, in a case where the manipulation information includes a stop instruction of the work machine and the state information includes movement of the work machine, the determination unit determines that there is the difference between the manipulation information and the state information.

8. The information processing device according to claim 1,
wherein the work machine includes a turning body that rotates in a predetermined turning direction, and
in a case where the state information includes rotation in a direction different from the turning direction, the determination unit determines that there is the difference between the manipulation information and the state information.

9. The information processing device according to claim 1,
wherein the work machine includes an undercarriage, a turning body, and an attachment.

10. The information processing device according to claim 1, further comprising:
a manipulation device;
a display device; and
an audio output device,
wherein the manipulation device, the display device, and the audio output device are provided near a cab seat of a cabin of the work machine.

11. The information processing device according to claim 10,
wherein the manipulation device is a manipulation unit by which an operator manipulates a hydraulic actuator that drives an operation element of the work machine, and the operation element is an undercarriage, a turning body, and an attachment.

12. The information processing device according to claim 10,
wherein the display device and the audio output device output image information and audio information to notify an operator under control of a controller.

13. The information processing device according to claim 12,
wherein the display device is a touch-panel type that also serves as at least a part of the manipulation device.

14. The information processing device according to claim 1, further comprising:
a communication device,
wherein the communication device is configured to mutually communicate with a remote external device or another work machine through a communication network.

15. The information processing device according to claim 14,
wherein the communication network is selected from among a mobile communication network including a base station as a terminal, a satellite communication network that uses a communication satellite in the sky, an Internet network, and a short-range communication network.

16. A non-transitory computer readable medium storing a control program of an information processing device including an image acquisition unit that acquires an image around a work machine, a recording unit that records the image acquired by the image acquisition unit, the program when executed by a processor, causing the processor to:
acquire manipulation information relating to a manipulation of the work machine;
detect a state of the work machine and acquire state information relating to the state;
determine whether or not there is a predetermined difference between the acquired manipulation information and the acquired state information; and
cause, in a case where determination is made that there is the difference between the manipulation information and the state information, the recording unit to record the image including at least an image at a point in time at which the determination is made that there is the difference.
